(19) United States
(12) Patent Application Publication
(10) Pub. No.: US 2004/0005887 A1
(43) Pub. Date: Jan. 8, 2004

(54) Collision free access scheduling in cellular TDMA-CDMA networks

(76) Inventors: Stefan Bahrenburg, Achim (DE); Rossella De, Milano (IT)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/612,897

(22) Filed: Jul. 7, 2003

Related U.S. Application Data
(63) Continuation of application No. PCT/EP02/00031, filed on Jan. 4, 2002.

(30) Foreign Application Priority Data
Dec. 1, 2001 (EP) 01 830 012.9

(51) Int. Cl. H04Q 7/20

(52) U.S. Cl. 455/422.1; 455/450

(57) ABSTRACT

A collision free access method is disclosed for scheduling the access of mobile stations to cellular network having an air interface built in TDMA-CDMA technique where the access procedure is performed on two steps: in the first the mobile station sends a signature for getting the network acknowledgement and the second step is for transmitting the RACH message and the RACH message can be of variable size. The proposed method allows for a multimode operation of the cellular network where the different modes allow for different RACH message sizes based on the fact that the mobile stations adapt the values of the parameters which control the access procedure based on the parameter values of the RACH message they are requested to send according to the supported mode.

The present invention is a continuation of international application number PCT/EP02/00031, filed Jan. 4, 2002 and further claims priority to European patent application 01830012.9, filed Jan. 12, 2001, both of which are herein incorporated by reference.

### BACKGROUND OF THE INVENTION

The present invention relates to the field of 3^{rd} Generation (3G) cellular systems and more particularly to a collision free access scheduling in cellular TDMA-CDMA networks.

A problem emerging in the above technical field is how to manage the transition towards the future UMTS (Universal Mobile Telecommunication System) 3^{rd} generation cellular systems. A few years is an optimistic period of time foreseeably taken for these systems to replace the existing ones. In the interim, manufactures are searching for hybrid solutions able to anticipate some technical features of the future systems without leaving existing infrastructures. The Applicant of the present patent application has been active in a development of CATT of a cellular system exploiting a Radio Access Technology named TD-SCDMA (Time Division-Synchronous Code Division Multiple Access). This technology is seen for use with two standards. One of them is specified by the Chinese standardization organization CWTS (Chinese Wireless Telecommunication Systems) and the other is a 3GPP standard, denoted as low chip-rate TDD (Time Division Duplexing) option, or 1.28 Mcps TDD. The system specified by the CWTS is based on GSM (Global System for Mobile communications) protocol stacks, and is in the latter referred to as TD-SCDMA&GSM, described in specifications named TSM. While the 3GPP standard is based on UTRAN (UMTS Terrestrial Radio Access Network) concepts, and is in the latter referred to as TD-SCDMA&UTRAN. A smooth migration between the TD-SCDMA&GSM and TD-SCDMA&UTRAN products has to be ensured, i.e. it shall be possible to use a TD-SCDMA&GSM terminal later on in a TD-SCDMA&UTRAN system for a certain transition period. In an early phase, systems like TD-SCDMA&GSM will be connected to a 2G (2^{nd} Generation) core Network. The physical layers of TD-SCDMA&GSM (standardized by CWTS) and TD-SCDMA&UTRAN (standardized by 3GPP) will be substantially the same. Products for the TD-SCDMA&GSM standard are foreseen to reach the market earlier than TDSCDMA&UTRAN. Products for the TD-SCDMA&UTRAN standard will be available much later. While still later in the future only TD-SCDMA&UTRAN products are foreseen to be used. There will be a transition period in which both system need to coexist on the same frequency spectrum. To allow a smooth migration from TD-SCDMA&GSM to TD-SCDMA&UTRAN it has to be possible to use TD-SCDMA&GSM terminals in the TD-SCDMA&UTRAN system at least for some period of time.

The problem of smooth migration outlines the need of a certain degree of compatibility between the two standards.

FIG. 1 depicts the physical TDMA-TDD basic frame common to the TSM and 3GPP standards. The frame has a sequential organization of 7 time intervals, or time slots, in addition to three other special time slots, which shall be described afterwards. The basic frame is indefinitely repeated for the use of a generic carrier among those in use in a cell. The basic frame of FIG. 1 includes m time slot UL#0, . . . , UL#m (UpLink) coming from the Mobile Stations (MS) or the User Equipment (UE) and n time slot DL#n, . . . , DL#0 (DownLink) coming from a Base Station (BTSC), being a full-duplexing of TDD type implemented.

By adding the CDMA capability to the TDMA-TDD basic frame of FIG. 1, the resulting set consisting of a carrier, a time slot of utilization of the carrier, and a spreading code forms a physical channel of the radio interface reserved to support an information characterizing the channel from the logic point of view. Although not shown in the Figures, the sequential frames are organized in more hierarchical levels observed by all the carriers used in the TSM and 3GPP systems. For instance it is possible for signaling opportunity to consider two consecutive basic frames of FIG. 1 as two sub-frames of a new frame having double duration, belonging to a multiframe of 72 new frames having 720 ms total duration.

The carriers transmitted by a BTSC transport reciprocally synchronize frames, thus simplifying the synchronization between adjacent cells. Without setting limits to the present invention, it is convenient to make a general frame synchronization among all the cells of the different clusters. Starting in the Figure from top to bottom, we see that the basic frame includes n+m=7 useful time slots, each one having 0.675 ms duration, in addition to other three special time slots, which are in order: a DwPTS time slot (Downlink Pilot Time Slot) of the duration of 75 μs, a 75 μs guard time GP, and a UpPTS time slot (Uplink Pilot Time Slot) of 125 μs duration. The total duration of the basic frame is 5 ms. In the basic frame the guard period GP represents the switching point DUUL. The guard period GP is used to avoid interference between uplink and downlink transmissions, as well as to absorb the propagation delays between the Mobile Station and the base station when the first one sends the first signal on the UpPTS channel; at this stage in fact the propagation delay is not yet known. Immediately before the guard period GP there is the special DwPTS time slot and immediately after the UpPTS time slot, both contain synchronization bursts not subject to spreading code. The remaining time slots contain bursts having a same structure, subject to spreading code, and destined to traffic or signaling. FIG. 2, shows a possible organization of the basic frame having high symmetry and particularly with starting point in UpPTS, followed by three uplink time slots, indicated in order Ts0, Ts1 and Ts2, then by four downlink time slots Ts3, Ts4, Ts5 and Ts6, and finally by DwPTS and by the guard time GP. Between time slots Ts2 and Ts3, there is the switching point UUDL. In FIG. 2, the duration of the different useful time slots is expressed through a measurement unit called chip, of the duration of 0.78125 μs, equal to the reciprocal of a chiprate=1.28 Mcps corresponding to the common frequency of a set of N sequences of codes used in a useful time slot to perform the spread spectrum according to the CDMA technique. FIG. 3 shows that the uplink pilot time slot UpPTS includes a 128-chip SYNC1 sequence followed by a 32-chip guard period GP. FIG. 4 shows that the downlink pilot time slot DwPTS includes a 32-chip guard period GP followed by a 64-chip SYNC sequence. And finally FIG. 5 shows that the common structure of useful time slots Ts0, . . . , Ts6 includes two fields having equal length of 352 chips for data, placed respectively before and after a 144-chip midamble, with a 16 chip guard period GP at closing, for a total of 864 chips. Each one of the two fields given in FIG. 5 is modulated by a pre-set number of sequence codes to generate an equal number of radio channels in the band of the spread spectrum, which individually occupy the whole band and represent a same number of so-called resource units RU (Resource Unit) put at disposal of the service and of the signaling. The midamble on its turn includes a training sequence used by the BTSC station and by the Mobile Stations to evaluate the impulse responses of the number of radio channels generated, for the purposes mentioned later on. With reference to the main burst of FIG. 5 the following relation applies: Tₛ^{k}=Qₖ×T_{c}, where Qₖ is a spreading factor SF (Spreading Factor), freely selected among 1, 2, 4, 8, and 16, corresponding to said number N of code sequences; Tₓ is the duration of a transmitted symbol, and T_{c} is the fix duration of the chip. From the relation it can be noticed that increasing the spreading factor also the duration of symbols transmitted increases, in other words, the physical channels associated to the main burst increase, but the transmission speeds allowed on the same decrease.

FIG. 6 shows the effect of a spreading factor 16 to create 16 new physical channels associated to each useful time slot belonging to the 5 ms basic frame of FIG. 1. The broadcast system information shall contain a trace of the association of the logical channel with the physical channels prefixed by P. The control channels considered in Figure represent an allocation set called CCHset (Control CHannel Set). In the TSM and 3GPP systems more than one CCHset can be configured. FIG. 6 shows a possible layout of a CCHset and of a P-FACH channel within the basic frame.

Relative to the transparent use by the network of the BCH (Broadcast CHannel) channels directed to the TSM and 3GPP Mobiles, each other distinct, this possibility is described in the European patent application No. 00830552.6, filed in both the name of Siemens Information and Communication Network S.p.A. and Siemens Aktiengesellschaft. The claimed solution exploits the QPSK modulation of the received DwPTS (Downlink Pilot Timeslot) for signaling the contents of the current frame. The combinations of the phases 45°, 135°, 225° and 315° are used to indicate the position of the BCH and the interleaving frame number relative to a fix phase reference. In other words BCH channels of two standards, like TMS and 3GPP, can be time multiplexed on the physical channel P-CCPCH (Primary Common Control Physical Channel) and the two types of UEs (User Equipment) independently demultiplex the proper BCH. The advantage is due to the coexistence of two different Mobile systems using the same frequency band without impacting the two standards.

Inventive solutions connected to the transparent use of BCH channels are undoubtedly important, because those channels carry the system information for cells, from which the subsequent operation completely depends. Research and development carried out in the laboratories of the Applicant made possible to wide exploit the BCH channel in 3GPP systems. Consequently some other procedure have to be considered as far as concerns the compatibility between the two standards. For example, taking into account that the Mobile identity, and therefore the supported TSM or 3GPP mode, can be known by the network only when the Mobile has already accessed to it is clear that all the procedures and messages exchanged before that time should be kept the same, at least at the network side. One of these procedures, named Random Access procedure, or RACH procedure, allows a Mobile to access to the system by means of co-ordinate exchanged messages. The RACH procedure is substantially completed in two steps involving two different access from the Mobile to the network. A first step is charged to randomly transmit signatures, or SYNC1 bursts, from the Mobile Station and accept the reply from the network with a single burst message, which allows the correct setting in the Mobile of its timing and power level for the next transmissions. This message is named respectively FPACH (Fast Physical Access CHannel) in TD-SCDMA&UTRAN specifications, or PFACH (Physical Forward Access CHannel) in the TD-SCDMA&GSM specifications. During the second step of the RACH procedure the Mobile transmits a RACH message to the network to make know its identity at the aim of accessing to a network service (e.g. asking for a channel).

In both steps of the RACH procedure regarding a cellular system TDMA-SCDMA-TDD, like 3GPP, the Applicant filed other patent applications to outline the opportunity to exploit system information broadcast in the BCH channel. Relevant arguments concerning the first step are disclosed in the International patent application PCT/IT00/00101.

The present invention, by way of background, includes the following characteristics with respect to the disclosed access channel scheduling process:

a) reading made by the Mobile Stations of appropriate access parameters (P1, P2, P3) inserted by the network in the system information carried by the above-mentioned service channel (BCCH) or in messages transmitted by the network at starting of procedures for the assignment of dedicated channels (TCH, SACCH, FACCH) to the Mobile Stations requesting at least an access of the Mobile Stations to the network;

b) generating by the Mobile Stations of the shared access subchannels (UpPTS_{SUBCH}) of said shared access channel (UpPTS), associating each subchannel to an access typology, through the use of said access parameters (P1, P2, P3);

c) transmission of one of said identification sequence (SYNC1), or signature sequence, on one of said shared access subchannel (UpPTS_{SUBCH}).

The shared access channels mentioned at step b) are the Uplink Pilot Time Slots UpPTS. The scheduling process needs at least two broadcast access parameters P1 and P2 that the Mobile Stations introduce in the following formal expression: SFN module [P1]=P2 calculated by the Mobiles to mark the frames numbered with the system frame number SFN as belonging to one said subchannel (UpPTS_{SUBCH}). The introduction of subchannels dedicated to the different access typologies, confers to a CDMA system the capability to regulate the access of the Mobile Stations on the shared channel. It is thus attenuated, the risk to congest the uplink path in the peaks of connection requests to the network, concerning all the modes foreseen by the system, such as for instance: in originated call, in ended call, in the asynchronous intercell handover, etc.

As far as concerns both the first and second step of the RACH procedure, the German patent application No 100 08 653.5 in the name of Siemens AG, outlines the opportunity to insert inside the system information carried from the BCH channel the associations of the following three channels: SYNC1-FPACH-PRACH. A similar association prevents signaling delays due to the systematic reading of the system information from Mobiles to know the right channel for receiving the network reply to a preceding SYNC1, or respectively to a Channel Request and in particular, to know which Parches have been configured, so that a Mobile can perform the random access procedure without colliding with other Mobiles.

### SUMMARY OF THE INVENTION

Having defined the Random Access procedure at a general level for introducing the prior art, some more precise information is required in order to better point out differences between the two modes, TSM and 3GPP, when accessing the network. For the TSM standard, the Random Access procedure follows the following steps:

1. The network transmits broadcast on the Broadcast Channel (BCH), besides other system information, the following:

the configured PFACHs, which are the physical channels from which the network will send its acknowledgements to the detected signatures;

the configured PRACHs, which are the physical channels on which the Mobile has to send its service request (through the RACH message) after detecting the acknowledgement to a previously sent signature from the FPACH.

the association between which signatures will be acknowledged by which FPACHs and which PRACH to use for an acknowledgement received by which FPACH; this association allows for optimizing the reception and transmission at the Mobile and avoid the collision on the PRACHs.

2. The signatures are sent by the Mobiles on the UpPTS physical channel and are given by a sequence of chips of known values; up to 8 different sequences are assigned. The Mobiles get the information of which sequences are in use in a cell through the synchronization process (see TSM and 3GPP specs for details).

3. The Mobile therefore selects a signature among the supported ones, waits for the acknowledgement from the associated FPACH for the next four sub-frames (5 ms) and detected the acknowledgement received by the configured FPACH.

4. The Mobile sends its RACH on the PFACH associated PRACH in a single burst (i.e. in 5 ms).

Also for the TD-SCDMA 3GPP standard, the network broadcast on the BCH the configured PRACHs and PFACHs (named FPACHS) and their respective association; the Mobile will start the random access procedure by selecting a signature on the UpPTS physical channel, waits for the acknowledgement and then sends the RACH message on the relevant PRACH (i.e. the PRACH associated to the PFACH from which the acknowledge was received) in a similar way as for TSM. Both for TSM and for 3GPP, the signatures, the UpPTS and the PFACH message are defined in substantially the same manner.

The big difference between TSM and 3GPP modes, as far as the Random Access procedure is concerned, is the expected capacity of the RACH message. The RACH message contains, in both modes, the request from the Mobiles to access the network services; through this message the Mobile declares its identity, and its supported mode, to the accessed system.

While for TSM mode this message requires only 32 bits, for 3GPP mode an average payload of 160 bits seems to be needed, but higher capacity is also possible. From this difference, it comes that if the TSM RACH message can be carried in a single burst, fitting in the 5 ms of one radio sub-frame, onto a single resource unit RU at Spreading Factor (SF) 16, for the 160 bits message of the 3GPP mode two basic resource units, at SF 16 each, or one resource unit at SF 8 for two radio sub-frames spanning 10 ms, would be needed. Of course different combinations are possible as well, playing on different SF or time duration value or on both parameters.

Taking into account that a dual mode cell will have one set of signatures only and one UpPTS channel only, it comes that all accessing Mobiles, whatever their mode may be, will send the same signatures on the same physical channel (the UpPTS) so that the dual mode Base Station will not know at that point in time the mode of the transmitting Mobile and has therefore to reply with the same FPACH acknowledgement message (i.e. having the same content and size).

We have now to consider that one big advantage of the TSM mode is the collision free state for the PRACH channel: when a Mobile accesses the PRACH for sending its RACH message, no other Mobile should send on that channel at the same time (of course, errors due to bad detection on both sides, Mobile or fixed, are still possible). In TSM mode, the RACH message takes one sub-frame only.

A detailed description of the RACH procedure in TSM mode is part of the relevant published specifications (CWTS TSM technical specifications). As a short summary useful for the disclosure of the technical problem to be solved, the basic points of the TSM RACH procedure are reported hereafter:

1. RACH message takes 1 sub-frame (e.g. 5 ms).

2. RACH message is sent exactly 2 sub-frames after the one carrying the PFACH burst sent as acknowledgement from the network.

3. Sending signatures is allowed at every sub-frame.

4. Sending the acknowledgement to a detected signature is allowed at every sub-frame.

5. The Mobile waits for an acknowledgement for up 4 N sub-frames after the one carrying the sent signature.

The following reports are an example of sub-frames occupancy for the above mentioned exchanged messages. With reference to FIG. 7: Example of sub-frame occupancy for RACH procedure in TSM mode and for all the following Figures, the different users (1, 2, etc.) correspond to different signatures as well; it is also assumed that the network replies to a detected signature exactly at the following sub-frame, though of course a processing delay in providing the acknowledgement is still possible. As can be seen from this example, no collision happens when sending the RACH message; note that user 5 will not access the system as not acknowledged by the network in the expected time: i.e. within 4 sub-frames.

In 3GPP standard currently the RACH procedure is under discussion, though it is quite confirmed that the RACH messages will have bigger size with respect to TSM such that even 2 or 4 sub-frames can be needed.

The aim is to preserve the collision free advantage on the RACH also for 3GPP mode, still keeping the possibility of having a dual mode network able to manage at the same time Mobiles of the two modes. So the designers need to take into account the time duration of the RACH message, as number of sub-frames, on a given physical channel PRACH without changing the network behavior with respect to the signature detection and the content of the acknowledgement messages. This implies that FPACH acknowledgement burst of 3GPP should be coded and sent in the same way as the PFACH for TSM.

Throughout the specification, the following defined acronyms will be used:

SFN: indicates the System Sub-Frame Number broadcast by the network;

L: represents the RACH message length in number of sub-frames;

WT: represents the Mobile maximum Waiting Time in number of sub-frames to wait for the network acknowledgement;

M: represents the maximum frequency in number of sub-frames for sending the signatures SYNC1; such that: a signature can be sent each SFN mod M=0 (eventually offset with an integer greater than 0, that we will not consider);

N: represents the maximum frequency in number of sub-frames for starting to send a RACH message; such that: a new RACH message can be sent at each SFN mod N=0 (eventually offset with an integer greater than 0 will be ignored as well).

In the configuration 1 for 3GPP mode which mostly reproduces the TSM parameters of FIG. 1:

1. L=2 (different from TSM);

2. N=2 (as for TSM);

3. M=1 (as for TSM);

4. WT=4 (as for TSM).

5. Sending the acknowledgement to a detected signature is allowed at every sub-frame (as for TSM).

Note that condition 4 has to be maintained the same as for TSM, in order to allow the concept of a dual mode network. Or, in another words, the network has to reply exactly with the same message and under the same timing constraints to a detected signature for all the supported modes. With these assumptions, collisions on the PRACH cannot be avoided; as shown in the following example of FIG. 8: Example of sub-frames occupancy for the above configuration 1 in a context 3GPP, where in gray it is marked the collision of users 2 and 3. Therefore, some of the assumptions above have to be changed.

If we change the WT value from 4 to 2 and keep unchanged the other conditions, we can have the following situation of FIG. 9: Example of subframes occupancy for configuration 2 in 3GPP, where collisions can occur again; in gray it is marked the collision of user 4 and user 5. Note that user 3 will not access as the acknowledgement comes too late.

If we change, with respect to configuration 2 in 3GPP, M value from 1 to 2, we will have the following situation of FIG. 10: Example of sub-frames occupancy for configuration 3 in 3GPP. Again, user 4 and user 5 collides when sending the RACH message. Note that user 3 will not access as the acknowledgement comes too late.

In another example: changing, with respect to configuration 3, the N value from 2 to 1 the situation will be the one of FIG. 11: Example of subframes occupancy for configuration 4 in 3GPP. Again collision can not be avoided and still user 3 will not access as the acknowledgement comes too late.

### SUMMARY OF THE INVENTION

The present invention is therefore directed to indicating the rules for the proper setting of the relevant parameters for sending and acknowledging the signatures, so that Mobiles of different modes: e.g. TD-SCDMA&UTRAN, or equivalently 3GPP, and TD-SCDMA&GSM, or equivalently TSM, can access in an efficient way to the same multi-mode network, without collision and the multi-mode network can reply in the expected way to Mobiles of different mode without the need to know in advance their specific type.

The same rules defined by the present invention equivalently apply to a single mode network, where the RACH messages which are sent by the mobile stations of the supported mode can be of variable size.

To achieve the above and other advantages the subject of the present invention is an access scheduling method in a cellular telephony system.

A first advantage of the present invention is the possibility to build a dual mode TD-SCDMA network which is able to allow the simultaneous access of Mobile of other modes with respect to TSM such that the RACH message collision is avoided in both modes, whatever the time duration of the message be.

A second advantage is the possibility to dynamically configure the Random access parameters, like RACH message time duration, frequency for sending signatures and signature acknowledge, waiting time at the Mobile for an acknowledge.

### BRIEF DESCRIPTION OF THE DRAWINGS

The invention together with further objects and advantages thereof, may be understood with reference to the following detailed description of one or more embodiments of the same, taken in conjunction with the accompanying drawings, in which:

FIGS. 1 to 5 depict several representations of a basic radio frame and the included bursts common to a TSM and 3GPP cellular telephony systems;

FIG. 6 shows a representation of physical and logic channels relevant to a basic frame of FIG. 1;

FIG. 7 is a table indicating the sub-frame occupancy for RACH bursts in TSM mode;

FIGS. 8 to 11 are several tables indicating as many sub-frame occupancy with RACH bursts for several configuration in 3GPP mode which don't reflect the method of the invention;

FIG. 12 is a table indicating the sub-frame occupancy for RACH bursts in TSM mode which reflects the method of the invention.

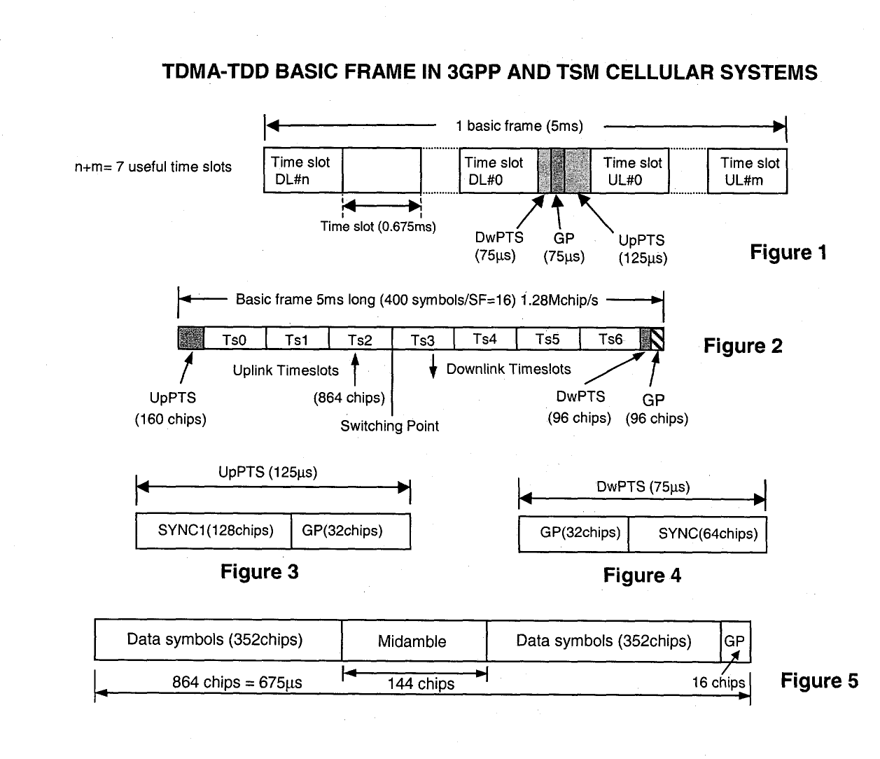

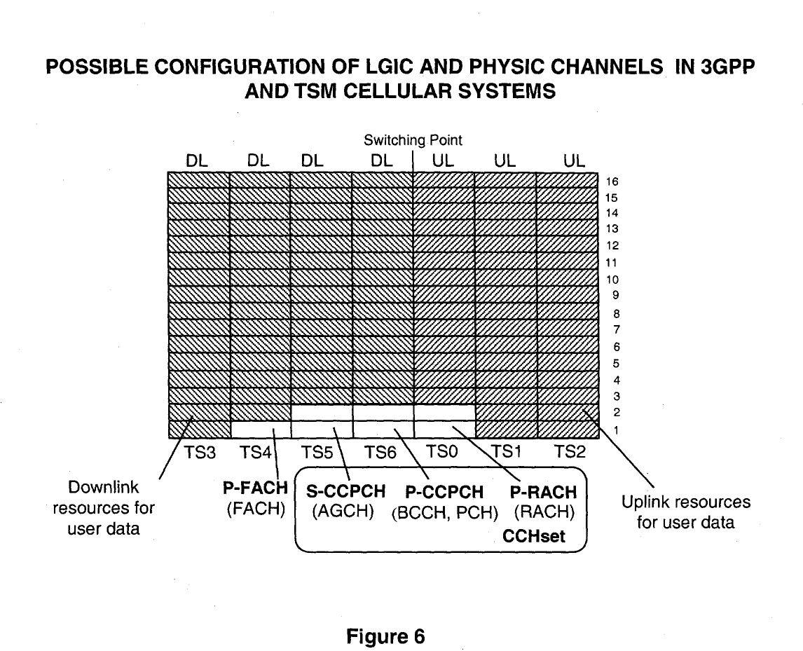

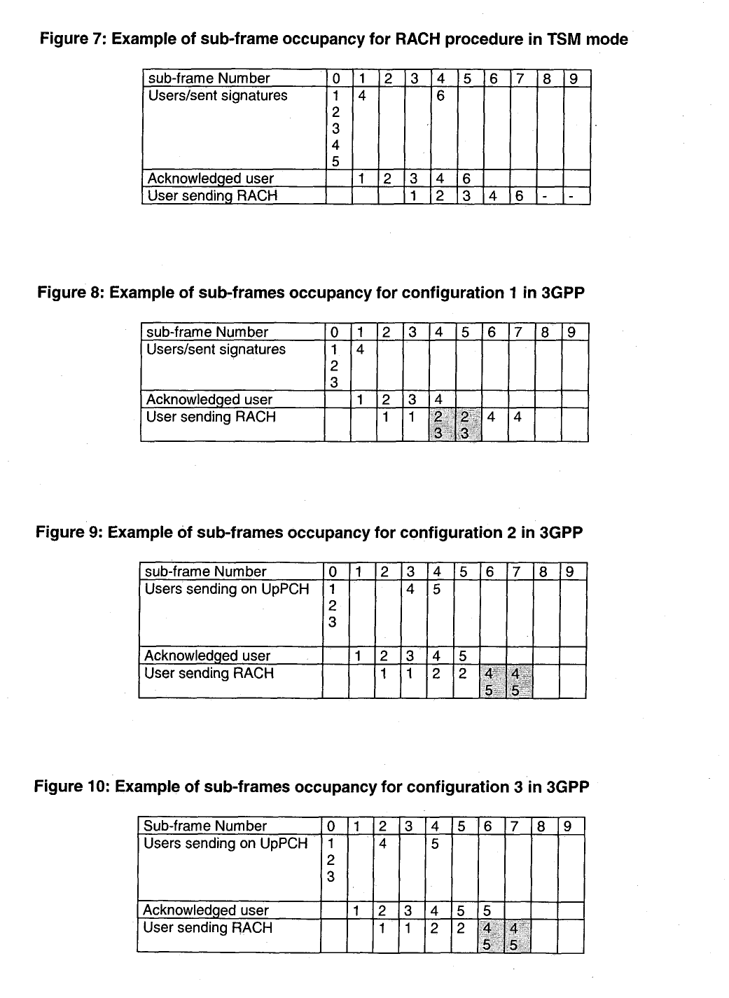

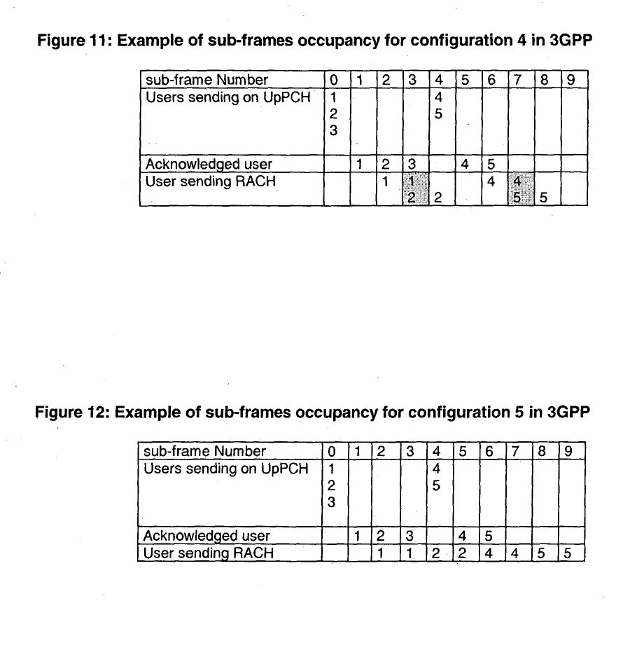

### DETAILED DESCRIPTION OF THE INVENTION

By way of conclusion to the above examples, it arises that all the involved parameters, described in the above list of definitions, are closely related to one another and that the definition of each of them has impacts and put requirements to others if collision on the RACH has to be avoided.

In particular, in changing the RACH message length, the maximum allowed waiting time should be changed as well as keeping unchanged the other parameters or changing the maximum frequency for sending a signature, the RACH message length has to be modified keeping the other parameters unchanged and so on.

The following rules are proposed for defining the values of the relevant parameters such that collision on the RACH can be avoided:

L×WT=M [1]

Equation [1] reports the relation between the RACH message length measured in L sub-frames; the maximum waiting time at the Mobile side for the network acknowledgement to the sent signature measured in WT subframes; and the minimum time interval for sending successive signatures measured in M sub-frames. So that for example doubling the RACH message length keeping the same maximum waiting time, requires the doubling of the minimum time intervals between two successive signatures etc.

Note however that the maximum waiting time has to be set within the following range of values:

0<WT≦integer [1/(L−1)]+1−(L−N)−(L−M) [2]

If a negative or null value for the WT is obtained, the selected setting of at least one of the other parameters (L; N, or M) has to be changed otherwise the Mobile access will fail (i.e. it will never succeed to get the network acknowledgement). If an infinite value is obtained (as for TSM), it means that any WT value is possible and therefore any M value is possible too; note however that a sensible maximum value for WT is 8, being the maximum number of signatures assigned to a TD-SCDMA cell both in TSM and 3GPP.

Equation [1] assumes that the network is able to acknowledge a detected signature immediately after the sub-frame; if this is not the case and for implementation reasons a fixed processing delay (maybe of one subframe) has to be considered, this can be taken into account as follows:

Defining D as the number of sub-frames the fixed delay by which the network replies to a detected signature, after resolving all relevant parameters values by applying equations [1] and [2], a new parameter, named WTu (waiting time updated) can be computed as the sum minus 1 of obtained WT and of the processing delay D. If WTu is equal to or less than the obtained RACH message, than the WT to be applied will be WTu; otherwise the obtained WT has to be confirmed.

As an example, if we now try to apply equations [1] and [2] to the previously described configuration 3, we can see that equation [1] is not satisfied; therefore one of the 3 parameter values (L, M or WT) has to be changed. If we change M from 2 to 4 the new scenario will be the one reported in FIG. 12: Example of sub-frames occupancy for configuration 5 in 3GPP.

In the operation:

1. The TDMA-CDMA network will broadcast on the relevant BCH the following parameter values, or part of them, or none of them if known or derivable by the mobile stations for each configured PRACH channel:

RACH message length as L number of sub-frames, or the relative number of bits;

the maximum Mobile waiting time WT as for example number of subframes for the network acknowledgement at the sent signature (SYNC1);

the maximum frequency for sending a signature, e.g. in number of M subframes between two successive signatures;

when it is allowed to send a RACH message, e.g. at each sub-frame mod N, with N an integer value greater than 0, coming exactly K sub-frames after the signature acknowledgement.

2. The Mobile operating in one network supported mode (e.g. 3GPP) can send, at the indicated (/known) sub-frames, the same signatures on the same UpPTS physical channels as a Mobile operating in another network supported mode (e.g. TSM).

3. The TDMA-CDMA cell will reply to the detected signatures sending the same acknowledgement messages and with the same timing constraints whatever the accessing Mobile mode may be.

4. The Mobile will wait up to the indicated (/known) maximum waiting time for signature acknowledgement, and if received in the due time, send on indicated (on the relevant BCH) PRACH, the RACH message starting at the network indicated (known) sub-frames and having the network indicated (/known) length.

Extensions on access channel scheduling will now be briefly discussed. The present invention is susceptible to some extensions beyond the not limiting embodiment described up to now. In particular, being the focus of the invention centered on the two step access procedure, in which possible collisions among RACH messages on the assigned PRACH physical channel are avoided thanks to a particular selection of the access parameter values, then it comes up consequently the possibility to exploit the teaching of the invention also in cellular systems built in conformance to different access techniques but also respecting the same two steps access. In particular the invention can be used in the following systems:

wide band CDMA cellular networks;

CDMA cellular networks with full-duplex FDD (Frequency Division Duplexing);

TDMA-CDMA-FDD cellular networks;

TDMA-CDMA-TDD cellular networks;

TD-SCDMA-TDD cellular networks.

The description has pointed out an important feature of the invention including the fact that the relevant values of the calculated access parameters like WT, N, M, strongly depend from the length of the RACH message. Before, in the description, the length L is supposed to be variable and not yet well defined. This is not a drawback but a good hint to emphasize the opportunity to carry out a single mode cellular system in which mobiles calculate from themselves the access parameters on the basis of known different lengths L of the RACH message. The consequent great advantage is the freedom in operation, being unnecessary the decoding of BCH information concerning the access parameters. This feature can also be maintained in multiple mode networks, where the Mobiles responding to modes that don't exploit this features can advantageously decode the relevant access parameters from the BCH information.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

We claim:

1. A method for scheduling an access channel in a cellular telephony system, said system based on CDMA techniques wherein individual coding sequences are substantially orthogonal to one another and are respectively assigned to the mobile stations for spread-spectrum modulating a common carrier in uplink, and de-spreading demodulating the downlink carrier, in order to make them distinguishable at the air interface, the system adopting a two step procedure for managing the mobile stations' network access, comprising the steps of:
selecting a signature burst from a plurality of orthogonal coding sequences;
transmitting said signature burst from said mobile station to said network, said transmission occurring over a first configured physical channel;
pausing for a select time interval;
after said step of pausing, transmitting an acknowledgement message from said network to said mobile station, said message being transmitted over a second configured physical channel, said second channel being one of directly and indirectly correlated to said first channel;
transmitting to said network from said mobile station an access request message on a third configured physical channel, said third configured channel being one of directly and indirectly correlated to at least one of said second and first channels;
assigning a set of signatures and an acknowledgement message into a cell;
calculating first time intervals at said mobile stations, said first time intervals indicative of when said signature bursts are transmitted;
calculating second time intervals at said mobile stations, said second time intervals indicative of a wait for arrival of said acknowledgement message from said network; and
minimizing collisions in said third configured physical channels between said access request messages sent from other mobiles stations via said first and second calculated time intervals depending on both a duration of said respective access request messages and delays in issuing said request messages.

2. The method according to claim 1, further comprising the steps of:
broadcasting, by said network, system information in a broadcast channel said mobile stations, said system information comprising at least one part of a plurality of access parameters, said access parameters comprising values of said first time intervals for said mobile stations transmitting their signature bursts, values of said delays for issuing said access request messages, and durations of said access request messages;
receiving said system information at said mobile stations; and
decoding, at said mobile stations, access parameter values associated with said mobile stations.

3. The method according to claim 1, further comprising the steps of:
assigning a carrier to said mobile stations;
completing spread spectrum modulation at said mobile stations, and an opposite operation, into a fixed duration of a time slot inserted in a basic sub-frame indefinitely repeated into frames and multiframes having embedded physical channels for transporting logical channels deputed either to traffic or exchange signaling in a multilevel protocol conformed to a standardized operative mode;
inserting synchronization bursts into pilot time slots,
adopting a synchronization procedure of said mobile stations based upon said pilot time slots; and
synchronizing said mobile stations such that respective signature bursts and positions of uplink pilot time slots carrying them, associations between signature bursts and position of said second configured physical channels carrying said acknowledge messages from said network, and wherein said association of a latter channel with position of said third physical channels for sending an access request messages having duration of a sub-frame or integer multiple are known to said mobile stations.

4. The method according to claim 2, further comprising the steps of:
assigning a carrier to said mobile stations;
completing spread spectrum modulation at said mobile stations, and an opposite operation, into a fixed duration of a time slot inserted in a basic sub-frame indefinitely repeated into frames and multiframes having embedded physical channels for transporting logical channels deputed either to traffic or exchange signaling in a multilevel protocol conformed to a standardized operative mode;
inserting synchronization bursts into pilot time slots,
adopting a synchronization procedure of said mobile stations based upon said pilot time slots; and
synchronizing said mobile stations such that respective signature bursts and positions of uplink pilot time slots carrying them, associations between signature bursts and position of said second configured physical channels carrying said acknowledge messages from said network, and wherein said association of a latter channel with position of said third physical channels for sending an access request messages having duration of a sub-frame or integer multiple are known to said mobile stations.

5. The access channel scheduling method according to claim 3, further comprising the steps of
transmitting a new access message at each sub-frame mod N whereby values of access parameters satisfy equation [1] L×WT=M, wherein:
L comprises a number of sub-frames or a relative number of bits of an access message length,
WT comprises a maximum mobile station waiting time in terms of subframes for network acknowledgement at a sent signature,
M comprises a number of subframes between two successive signatures identifying a maximum frequency for sending a signature,
N comprises a value greater than 0, and
mod N comprises a time when a new access message may be transmitted for at a maximum frequency in number of sub-frames for starting a transmission of an access message after said signature acknowledgement,
determining if said network is able to acknowledge a detected signature,
performing said step of transmitting a new access message within a subframe immediately after said detected signature, if said network is determined to be able to acknowledge said signature, and wherein
a maximum waiting time WT is set within a following range of values according to equation [2] 0 <WT≦integer [1/(L−1)]+1−(L−N) (L−M), such that if a negative or null value for the WT is obtained, the selected setting of at least one of said other parameters L, N, M is changed to allow network acknowledgement.

6. The access channel scheduling method according to claim 4, further comprising the steps of
transmitting a new access message at each sub-frame mod N whereby values of access parameters satisfy equation [1] L×WT=M, wherein:
L comprises a number of sub-frames or a relative number of bits of an access message length,
WT comprises a maximum mobile station waiting time in terms of subframes for network acknowledgement at a sent signature,
M comprises a number of subframes between two successive signatures identifying a maximum frequency for sending a signature,
N comprises a value greater than 0, and
mod N comprises a time when a new access message may be transmitted for at a maximum frequency in number of sub-frames for starting a transmission of an access message after said signature acknowledgement,
determining if said network is able to acknowledge a detected signature,
performing said step of transmitting a new access message within a subframe immediately after said detected signature, if said network is determined to be able to acknowledge said signature, and wherein
a maximum waiting time WT is set within a following range of values according to equation [2] 0 <WT<integer [1/(L−1)]+1−(L−N)−(L−M), such that if a negative or null value for the WT is obtained, the selected setting of at least one of said other parameters L, N, M is changed to allow network acknowledgement.

7. The access channel scheduling method according to claim 5, further comprising the steps of:
defining D as a number of sub-frames equal to a fixed delay by which said network acknowledges a detected signature;
defining WTu as an updated waiting time WT;
resolving relevant access parameters values by applying equations [1] and [2]
executing equation [3] WTu=WT+D−1;
executing equation [4] WTu<L so as to arrive at a true or false value;
applying Wtu if equation [4] is true; and
confirming WT if condition [4] is false.

8. The access channel scheduling method according to claim 6, further comprising the steps of:
defining D as a number of sub-frames equal to a fixed delay by which said network acknowledges a detected signature;
defining WTu as an updated waiting time WT;
resolving relevant access parameters values by applying equations [1] and [2]
executing equation [3] WTu=WT+D−1;
executing equation [4] WTu<L so as to arrive at a true or false value;
applying Wtu if equation [4] is true; and
confirming WT if condition [4] is false.

9. The method according to claim 1, wherein:
said network is able to support additional standardized operative modes for servicing a plurality of additional sets of mobile stations sharing subframes, frames and multiframes, after access has been completed;
said network broadcasting system information is assigned at operative modes through logical channels; and
each of said additional sets of mobile stations performs the step of selecting a proper channel for receiving its own system information and decoding access parameter values.

10. The method according to claim 2, wherein:
said network is able to support additional standardized operative modes for servicing a plurality of additional sets of mobile stations sharing subframes, frames and multiframes, after access has been completed;
said network broadcasting system information is assigned at operative modes through logical channels; and
each of said additional sets performs the step of selecting a proper channel for receiving its own system information and decoding access parameter values.

11. The method according to claim 3, wherein:
said network is able to support additional standardized operative modes for servicing a plurality of additional sets of mobile stations sharing subframes, frames and multiframes, after access has been completed;
said network broadcasting system information is assigned at operative modes through logical channels; and
each of said additional sets performs the step of selecting a proper channel for receiving its own system information and decoding access parameter values.

12. The method according to claim 5, wherein:
said network is able to support additional standardized operative modes for servicing a plurality of additional sets of mobile stations sharing subframes, frames and multiframes, after access has been completed;
said network broadcasting system information is assigned at operative modes through logical channels; and
each of said additional sets performs the step of selecting a proper channel for receiving its own system information and decoding access parameter values.

13. The method according to claim 7, wherein:
said network is able to support additional standardized operative modes for servicing a plurality of additional sets of mobile stations sharing subframes, frames and multiframes, after access has been completed;
said network broadcasting system information is assigned at operative modes through logical channels; and
each of said additional sets performs the step of selecting a proper channel for receiving its own system information and decoding access parameter values.

14. The method according to claim 9, wherein:
said network is able to support additional standardized operative modes for servicing a plurality of additional sets of mobile stations sharing subframes, frames and multiframes, after access has been completed;
said network broadcasting system information is assigned at operative modes through logical channels; and
each of said additional sets performs the step of selecting a proper channel for receiving its own system information and decoding access parameter values.
